(19) United States
(12) Patent Application Publication
(10) Pub. No.: US 2026/0179331 A1
(43) Pub. Date: Jun. 25, 2026

(54) DIGITAL ENHANCED VISION SYSTEM WITH AUGMENTED REALITY DISPLAY

(71) Applicant: Sage Technologies, Ltd., Warminster, PA (US)

(72) Inventors: Wesley Sheridan, Chalfont, PA (US); Russell O'Rourke, Telford, PA (US); Gustav Witzel, Warminster, PA (US); Brent Munsell, Doylestown, PA (US); Ofir Shavit, Bryn Mawr, PA (US); Joseph Straub, Falls Church, VA (US)

(21) Appl. No.: 19/418,378

(22) Filed: Dec. 12, 2025

Related U.S. Application Data
(60) Provisional application No. 63/733,777, filed on Dec. 13, 2024.

(51) Int. Cl. G06T 19/00

(52) U.S. Cl. CPC G06T 19/006

(57) ABSTRACT

A helmet-mounted digital enhanced-vision system for mobile field personnel integrates a compact main housing releasably attached to the front of a helmet. The housing contains a forward-facing sensor camera grouping with electro-optical/infrared (EO/IR) sensors that capture real-time multispectral imagery. An adjustable monocular eye display subsystem, positioned beneath the housing and alignable with either eye, presents a direct optical view of the real world while overlaying geo-registered augmented-reality symbology. An onboard augmented-reality processing unit fuses sensor data, head-tracking information, and positioning inputs to precisely align and stabilize the symbology with real-world geographic coordinates, thereby providing accurate, world-locked situational awareness without requiring off-helmet equipment.

### CROSS REFERENCE TO RELATED APPLICATIONS

This application claims the benefit of U.S. Provisional Application No. 63/733,777 filed Dec. 13, 2024, the entire disclosure of both are incorporated herein by reference.

### STATEMENT REGARDING FEDERALLY SPONSORED RESEARCH OR DEVELOPMENT

This invention was made with government support under Phase I SBIR Government contract FA-8650-17-P-6881 awarded by the United States Air Force. The government has certain rights in the invention.

### BACKGROUND

### Field

The present invention relates to the field of visual aid systems intended to assist the operational effectiveness of military, law enforcement and other emergency field personnel, and more particularly, to an improved digitally enhanced vision system designed to be used by such field personnel to maximize visual observations of an incident site regardless of the ambient conditions at the site and featuring an augmented reality operator display to provide the personnel with increased situational awareness.

### Background

Tactical surveillance and reconnaissance missions conducted by military, law enforcement and other emergency field personnel require the personnel to be equipped with the capability of reliable and effective recognition and identification of any and all threats within the scope of immediate surveillance regardless of the degree of clarity or obscurity of the ambient environment. Such capability has typically been provided to surveillance and reconnaissance personnel using one or more electro-optical sensor cameras to detect the illumination reflected from and/or emitted by an object within an observed scene that may prove to be a recognized threat. Many of these cameras operate by sensing reflected illumination in the 400-700 nm visible (VIS) band. Beyond the VIS band, existing analog night vision goggles operate by sensing ambient illumination reflected off of scenes in the 625-930 nm near infra-red (NIR) band, thus encompassing part of the visible and near infra-red (VNIR) electromagnetic spectrum. To provide increased threat detection, additional night/day sky illumination energy is available in the 0.9-3.5 um short-wave infra-red (SWIR) spectral band, with additional emissive energy capable of being detected in both the 3-6 μm mid-wave infra-red (MWIR) and the 7-15 μm long-wave infra-red (LWIR) spectral bands. Sensor cameras operating in the SWIR and MWIR bands have a unique ability to see through atmospheric obscurants (e.g. fog, haze), improve detection of VNIR camouflage, and can further detect out-of-VNIR band lasers, thus becoming an important front-end element of many visual aid systems in tactical operations. Longer wavelengths of the MWIR and LWIR bands emitted from terrestrial thermal sources, such as vehicles, engines, humans, and animals emit are of value in their detection and recognition. However, these longer wavelengths are limited in their usage and generally unusable when detecting through transparencies, such as lenses in dust goggles or canopies/windows in aircraft, typically made of materials like BPA-based polycarbonates which cut-off with transmission beyond SWIR. Subject to the operating limitations of these selected bands, systems having multi-spectral capabilities have been developed to provide operating personnel with needed flexibility in dealing with various ambient environments and an effective range of threat identification and recognition.

Despite the development of multi-spectral vision systems equipped to be worn by these military and tactical field operators, there remains an evident need to enhance the situational awareness of these operators that can serve to update them at all time as to the field environment and the incident scene under surveillance. For this purpose, augmented reality display systems have been considered and proposed for adaptation and integration to current visual-aid systems, particularly those that are worn on or about the head of the field operator/user. Augmented reality, as it is generally known, is a means for producing a live direct or indirect view of a physical, real-world environment whose elements are augmented (or supplemented) by computer-generated sensory input such as sound, video, graphics, global positioning system (GPS) data or the like. Augmented reality display systems have been integrated into head-up displays, head-mounted displays, cellular phones, computers, tablets, or the like. However, typical augmented reality display systems suffer from high latency, rainbow effects and non-conformal imagery that result from movement in either the display itself or the user's head/eyes so that the image on the display must be continuously updated. Some augmented reality displays, for example, excite red, green and blue pixels at different times to form an image. When a user or display is moved faster than a single excitation cycle through the colors, rainbow effects can appear as the different colors are overlaid over different areas rather than on top of one another. Furthermore, the images in conventional augmented reality displays tend to be non-conformal. In other words, in typical augmented reality displays the displayed image tends to jitter, have delayed movement or otherwise appear where it should not appear. These effects can cause nausea and disorientation in some users.

Accordingly, there is an unmet need for a low-latency, digital AR display seamlessly integrated with multi-spectral visual-aid systems for field personnel. Such a system should be helmet-mounted, positioned near-to-eye, and engineered for robust digital operation to ensure maximum performance across night, day, and all-weather conditions.

### SUMMARY

Accordingly, it is a general purpose and object of the present invention to provide an improved visual-aid system for use by military and law enforcement personnel that maximizes the visual and environmental awareness of the personnel when using the system during field operations regardless of the ambient conditions.

A more particular object of the present invention is to provide an improved visual-aid system able to be carried with and/or worn upon field personnel that is capable of providing digitally enhanced images of a site to the user-personnel selectively based on the ambient conditions and further display physical, real-world data and graphics regarding the site location and the environment of the user-personnel to enhance the situational awareness of the user-personnel.

Another object of the present invention is to provide an improved digital enhanced vision system featuring a low latency augmented reality display for field personnel that is integrated in its design and adapted for proper placement upon the head of the user-personnel in a stable operational position near-to-eye to provide maximum performance in the field in night, day, and all-weather operations.

Still another object of the present invention is to provide an improved digital enhanced vision system integrated with a low latency augmented reality display that is lightweight and portable and made conformal to standard helmets for ready engagement and balanced mounting upon the head of the operator, reducing head and neck strain over extended periods of without impairing normal head movements and sighting.

A still further object of the present invention is to provide a digital enhanced vision system with low latency augmented reality display that is user-friendly in its controls and reliable in its performance, affording greater viewability and recording capabilities regardless of environment conditions.

Briefly, these and other objects of the present invention are accomplished by an improved digital enhanced vision system featuring an augmented reality operator display and comprising multi-spectral electro-optical sensor cameras to detect selective bands of multiple reflective and emissive illumination from an observed scene and produce real-time high resolution imagery data therefrom. The inventive system digitally fuses the real-time high resolution imagery data and in turn displays captured images of the scene supplemented with symbology and imagery data gathered and interfaced from an external augmented reality source to provide the user-operator with greater situational awareness of the location and surrounding environment. The vision system serves particularly well for night ground operations and may be hand-held or preferably mounted upon the head of the operator or a helmet worn thereon.

The inventive system is designed with multi-spectral imaging to afford night, day and all-weather operational performance and provides various advanced control capabilities by means of the digital processing techniques that include digital enhanced zoom, image stabilization for better viewing while moving, near-far focus, parallax correction, and moving target indicators to assist the user in the improved detection of threats. The augmented reality display feature is characterized by low latency operation and may be used in monocular, binocular and biocular modes. The binocular mode may exceed the power threshold depending on other system selected operating modes when concurrently active. A “digital only” mode may also be employed in which sensor imagery is not displayed. The present inventive system is designed to interface with external systems to receive off-helmet tactical information for display and to output sensor and tactical information for data and imagery sharing.

Accordingly, the present invention provides a digital enhanced-vision system specifically adapted for mobile use by field personnel. The system comprises a main housing releasably mountable to a forward portion of a helmet and having a front end. Located at the front end is a sensor camera grouping comprising electro-optical/infrared (EO/IR) sensors configured to collect observed imagery from the environment.

An adjustable eye display subsystem is disposed beneath the main housing and is positionable in front of either the left or right eye of a user. The eye display subsystem is configured to overlay augmented-reality symbology on the user's direct optical view of the real world while maintaining see-through capability.

A central augmented-reality processing unit geo-registers the displayed symbology to real-world geographic coordinates. Geo-registration is achieved through the coordinated operation of a helmet-mounted tracker subsystem that measures relative changes in head pose of the helmet and a separate geospatial tracker subsystem that determines absolute three-dimensional position and absolute angular orientation of the helmet in a geospatial coordinate system.

In certain embodiments, the system further includes a self-contained GPS subsystem comprising an integrated GPS receiver and antenna configured to determine absolute geographic position of the helmet independently of any external navigation aids or equipment carried by other personnel, with the GPS subsystem outputting the absolute geographic position to the augmented-reality processing circuitry for use in geo-registering the displayed symbology.

The EO/IR sensors include at least one reflective-band sensor comprising one or more Vis/NIR sensors configured to capture light in the visible and near-infrared portions of the electromagnetic spectrum and at least one emissive-band sensor comprising one or more LWIR sensors that capture thermal radiation in the long-wave infrared part of the spectrum. Additional embodiments incorporate a short-wave infrared (SWIR) sensor.

Processing is performed by a field-programmable gate array (FPGA)-based central microprocessor that receives imagery from the sensor camera grouping and generates both the observed imagery and augmented-reality metadata for presentation on the eye display subsystem. The system supports user-selectable controls for filtering and managing displayed data, digital enhanced zoom, image stabilization, parallax correction, moving-target indicators, and a digital-only mode in which live sensor imagery may be suppressed while geo-registered symbology remains active.

The entire system, including power, sensors, processing, and display components, is fully integrated onto the helmet, enabling completely untethered operation in contested or austere environments.

For a better understanding of these and other aspects of the present invention, reference should be made to the following detailed description taken in conjunction with the accompanying drawings in which like reference numerals and character designate like parts throughout the figures thereof.

### BRIEF DESCRIPTION OF THE DRAWINGS

For a fuller understanding of the nature and objects of the present invention, references in the detailed description set forth below shall be made to the accompanying drawings in which:

FIG. 1 is a functional block diagram showing the system architecture of essential component elements for a helmet-mounted embodiment of the present digital enhanced vision system in accordance with the present invention;

FIG. 2 is a top plan image of the helmet-mounted embodiment of the present inventive system;

FIG. 3 is a front elevation view of the helmet-mounted embodiment of the present invention of FIG. 2 further showing the electro-optical sensor unit housed in a contained state over the eyes of the user-operator;

FIG. 4 is a front perspective view of the helmet-mounted embodiment of the present invention of FIG. 2 further showing the electro-optical sensor unit with a portion of its housing removed;

FIG. 5 is a front perspective view of the electro-optical sensor unit shown in FIG. 3 separated from its mounted position at the front end of the helmet; and

FIG. 6 is a front perspective view of the electro-optical sensor unit shown in FIG. 4 separated from its mounted position at the front end of the helmet.

### DETAILED DESCRIPTION

The following serves to describe a preferred embodiment of the present invention and the best presently contemplated mode of its production and practice. This description is further made for the purpose of illustrating the general principles of the invention but should not be taken in a limiting sense, the scope of the invention being best determined by reference to any associated claims.

Referring to the drawings, the following is a list of component elements of the present digital enhanced vision system, generally designated 10, and those associated assemblies employed in connection with the present invention:
10 digital enhanced vision system;
12 central microprocessor;
14 sensor camera grouping;
16 VIS/NIR sensor;
18 SWIR sensor;
20 LWIR sensor;
22 AR firmware;
24 eye displays;
30 head tracker subsystem;
40 helmet tracker subsystem;
50 GPS subsystem;
60 display subsystem;
65 display optics;
80 AR overlay;
90 main system housing;
92 battery housing;
94 latch mechanism;
96 helmet shroud; and
H protective helmet

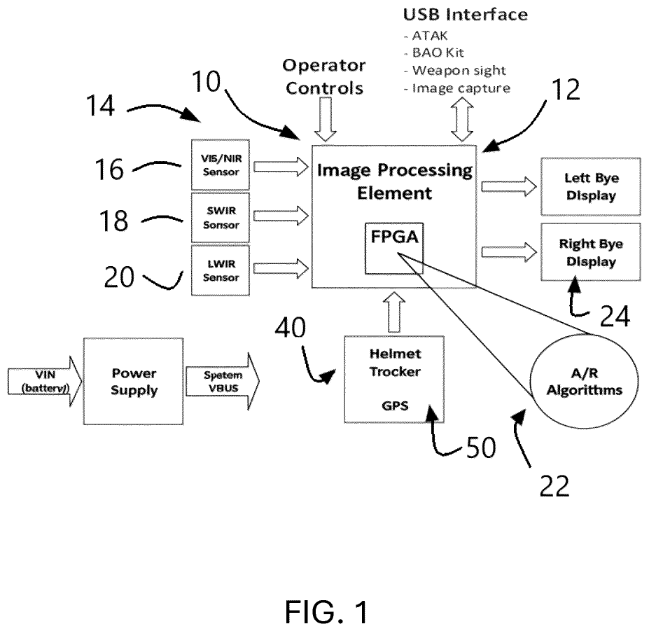

Referring initially to FIG. 1, a functional block diagram is shown depicting key working components of the present inventive system 10 and their interrelationships for imagery and data generation, interfacing, processing and displays. External data interfaces and interface types for communicating with off-helmet systems are also indicated. A central microprocessor unit for image processing 12 in the form of a field programmable gate array (FPGA) is used to control the data flow and perform the necessary processing requirements of the present inventive system 10 and further supports the augmented reality (AR) capability thereof. The central microprocessor unit 12 is operatively connected to receive the imagery collected from a sensor camera grouping 14 set at the front end of the system 10, the sensor camera grouping having at least one reflective and one emissive band sensor.

In the current preferred embodiment of the present system 10, the sensor camera grouping includes a VIS/NIR sensor 16 and a SWIR sensor 18 for reflective sensing and a LWIR sensor 20 for emissive detection. To maximize image detection and the collection of image data for processing, the user/operator may select any combination of sensor inputs from the sensor camera grouping 14 as may be needed to simultaneously meet all performance requirements for a particular venue and application. The central microprocessor unit 12 combines the image data from the sensor camera grouping 14 with additional data inputs from external sources such as GPS and geospatial applications, and with embedded AR firmware 22 that correlates and generates the meta data for observed imagery, outputs the resultant imagery and AR meta data to eye displays 24 for operator viewing. The AR firmware 22 also supports operator controls and preferences for selecting, filtering and controlling the data for best performance and display to the operator.

The present inventive system 10 comprises and combines a plurality of subsystems to effect and maximize its operational performance. A head tracker subsystem 30, separate from a position tracking subsystem described in greater detail below, is designed and intended to produce absolute helmet position and angular orientation of the user-wearer in geospatial coordinates. Head tracking is a technique that combines image feature selection, registration, tracking, and helmet position and angle calculation processes to provide accurate operator helmet orientation in geospatial coordinates. The present inventive system 10 integrates its internal image processing and other sensing technologies together with the head tracker subsystem 30 to provide accurate helmet tracking of the user-wearer in the field at real-time video speed. This results in accurate, low latency situational awareness indications for the user. An example of a suitable head tracker capable of interfacing with the present inventive system 10 is a wearable head tracking system, known as “WANDER.”

Such a wearable head tracking system provides real-time, low-latency helmet navigational position and directional state (pointing angle, acceleration and velocity) by which the present inventive system could accurately position its Augmented Reality (AR) 11 display, spatially aligned to the user-wearer's optical view of his or her surroundings. The Head Tracker WANDER system calculates the helmet state using a unique synchronization of: (1) low-drift inertial measurement unit (IMU) data, (2) innovative video-based navigation and pointing angle processing, and (3) GPS updates from a GPS receiver when they are available, combining these three types of navigation and tracking systems (inertial, video, and occasional or sparse GPS) to ensure a continuous, low-latency, highest-accuracy helmet state calculation to support a real-time AR display. For such an example as WANDER, design and implementation of a data interface using standard interfaces and protocols operate as the head tracker subsystem 30 of the present inventive system 10, with such data interface being uncomplicated and achievable by a one of ordinary skill in the art using the standard interfaces and protocols afforded.

In addition to the head tracker subsystem 30, the present inventive system 10 includes and employs a helmet tracker subsystem 40 to achieve the proper geo-positioning of the symbology so that user-operator position, azimuth, and elevation are measured to the required accuracy. The present system 10 further integrates a Global Positioning System (GPS) subsystem 50 as an essential system component to provide geographic locational information as to the contested environment of the user-operators, particularly in their mobile capacity, relative to other objects and personnel. The GPS subsystem 50 is operatively connected to feed the output signal and its corresponding locational data into the AR firmware 22 and its processing elements and has an internal GPS to function independently of any operational equipment carried by the user-operator and other external systems. There are any of a variety of commercially available GPS substitute devices and modules that may be adapted and used to support the operation of the GPS subsystem 50 in the present inventive system 10.

A display subsystem 60 preferred for the present inventive system 10 is of the type having a transparent see-through display panel upon which image sensor and AR data is projected onto the clear panel for the user-operator. Current display technology was evaluated and assessed to determine the preferred solution that could achieve the inventive system requirements. One particular issue under consideration focused on the operational differences between see-through displays and opaque displays under daylight and night conditions. Component selection for each of these forms of display addressed sensor imagery, AR data and symbology, and daytime versus nighttime operation. The imaged field of view was also evaluated as well as the latest technology optical methods to achieve a field of view in a near eye display, along with mechanical display packaging.

In comparative analysis of both opaque and see-through configurations, a system configuration with permanent opaque displays is not considered an optimal configuration for daytime performance because it will require the user-operator to rely on the video feed from a visible camera for simple day time operations. See-through displays, on the other hand, can result in the exposure of the user to detection by hostile forces during nighttime use. A transparent see-through display is more effective for day time operations with the AR data projected to the user. With a clear display the operator will have an unobstructed view of the daytime environment when in full light condition. In a binocular or binocular implementation both eye pieces will be operational and in the operator's line of sight. Based on current display technologies available, a preferred see-through display subsystem 60 is a specially adapted see-through display with field of view greater than 50 degrees.

The LWIR sensor 20 is an excellent complement to reflective bands and continual improvements have driven these devices to favorable performance characteristics suitable for use in the present inventive system.

For suitable sensors in a reflective band, selection focused on those camera/sensors in the Vis/NIR spectrum. The Vis/NIR sensor 16 found most preferable for use as the reflective sensor in the present inventive system 10 includes the Intevac EBAPS and Photonis Nocturn families of cameras that meet and in some areas exceed the threshold criteria required. Other Vis/NIR sensor are also suitable for use and fall within the scope of the present invention.

As for the camera/sensor optics employed in the present inventive system 10, each camera selection requires a corresponding lens to achieve the required Field of View (FoV) as well as other desired size and weight characteristics. The lens selection for the LWIR band sensor is generally limited to what the camera manufacturer is able to supply pre-installed and calibrated to each sensor. As an alternative to any of those, a custom lens arrangement may be used to meet the image circle requirements of the large FPA and the established SWaP performance criteria.

The central microprocessor module 12 serves a vital functional role in the present inventive system in that it serves not as a digital vision processor of the image data generated from the Vis/NIR reflective band sensor 16 and the LWIR band sensor 20 but also as an AR processor of the AR data delivered by the AR firmware 22. The vision processing element is similar in functional capability to those digital image processors currently employed in the Vision Processor for Helmet System (VPHS) and the Low-Latency Embedded Vision Processor (LLEVS), both developed by Sage Technologies, Ltd. As for providing the additional AR data processing capability required and its associated software platform, FPGA-based processors are capable having been used in connection with low-latency image processing algorithms. An FPGA-based image processing element developed by Sage Technologies, Ltd. is adaptable and recognized as capable of being augmented to support AR capability. Considering the compatibility shown between AR and vision processing algorithms, an MPSoC (Multi-Processor System-on-a-Chip) FPGA device may be adapted and used for the system processing platform of the present invention. These MPSoC devices provide a programmable FPGA fabric for the hardware acceleration needed for vision processing pipelining, along with embedded CPU cores which can be used for advanced vision and AR processing algorithms.

For the benefit of providing the user-operator with greater situational awareness in the field, the present inventive system 10 integrates a basic AR functionality to accomplish this enhanced performance objective. It is important from an operator human factors perspective that the symbology and AR interface be clearly understood, have a short learning curve, and be common to other platforms in the operator's environment. Because much of the current AR software developed currently is used in connection with a specific hardware system and not generally available as a stand-alone product, the present AR software used in connection with the present inventive system 10 is specially modified and integrated with the system hardware platform, including its processor, IMU, camera sensors and optics. In designing the AR software for optimal benefits in the present case, the AR software overlay application in the present inventive system 10 will perform the following basic functional tasks:
1. Receive geopositioned information about terrain and scene around the operator from an external source.
2. Receive mission relevant data from an external source.
3. Place markers and icons on a video overlay of the scene via the display to show features of interest, compass heading, and the mission relevant data.
4. Read and interpret the scene as it receives data from the system sensors and cameras.
5. Identify scene features such as personnel and objects and make image analysis of this data on board the system processor, place markers on these features using a video overlay that is projected on the operator display.

The AR tactical symbology and information processed and generated from the AR firmware 22 is displayed on an AR overlay 80 incorporated on the user-operator's helmet mounted display, with the tactical symbology being displayed to the operator in accordance with MIL-STD-2525D. A further AR capability will utilize Cursor-on-Target to facilitate interoperability with already existing software in the field. Besides the military standard symbology and operator preference symbology currently intended for the AR display, additional capabilities derived from the system software platform will accommodate the display of other specific AR display symbology as it is becomes standardized.

The present system inputs for symbology, data and imagery will be acquired from both internal and external sources by interfacing with the system. The interface with the external system may be provided in a tethered format or transmitted/received via short range wireless link. Power will be supplied via the internal batteries or from the external system tether where available. Another optional capability would include wireless power and data. Since the present inventive system has a near eye display and wired/wireless communication capability built in, provisions for a remote weapon aiming system could be integrated in the system. This will assist the operator in weapon aiming while keeping eyes on the other mission surrounding elements displayed through both eye pieces and keeping a weapon on target. A wireless remote aiming system for weaponry could be utilized for this purpose.

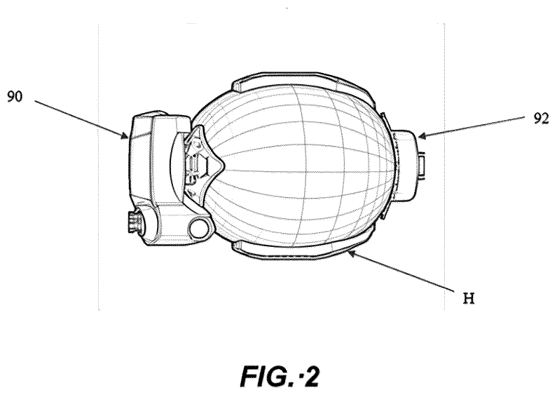

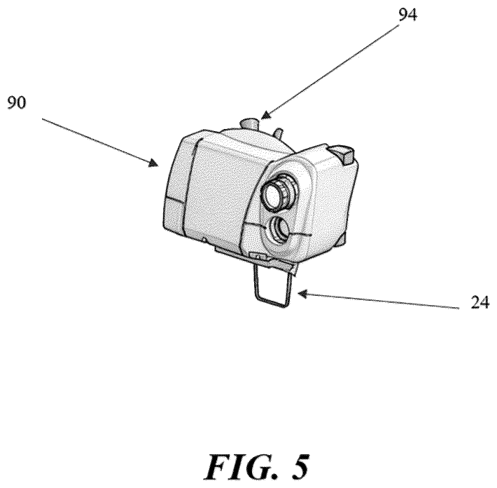

Referring now to FIGS. 2-6 in conjunction with FIG. 1, a preferred helmet-mounted embodiment of the present inventive system 10 is shown in FIG. 2 with a main housing unit 90 stationed at the front end of a protective helmet H and a battery housing 92 mounted at the back of the helmet with a removable battery cartridge. The main housing unit is compactly sized and equipped to hold the operational subsystems including the central microprocessor module 12, sensor camera grouping 14 with its Vis/NIR and LWIR sensors and associated optics, the display subsystem 60 with its optics 62 and eye displays 24. The rear-mounted battery housing 92 and cartridge provides for wired or wireless access to an external device and serves as a counterbalance to reduce the system moment arm. An alternative variant to this mounted arrangement of the inventive system 10 would remove the rear battery housing 92 entirely and instead, contain the batteries in the main housing unit 90 at the front. This variant would afford the smallest and lightest overall configuration but likely require some moment arm corrections with counter-balance methods, and external interfaces would need to be accommodated with a rear mounted connector interface.

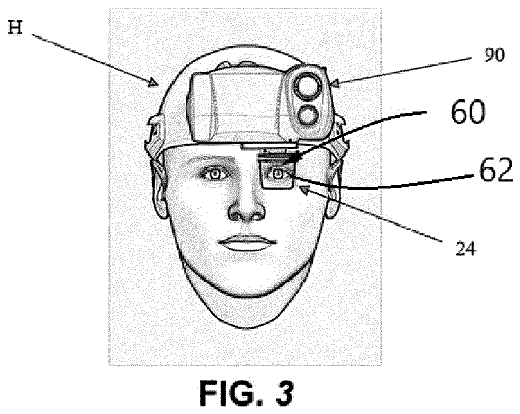

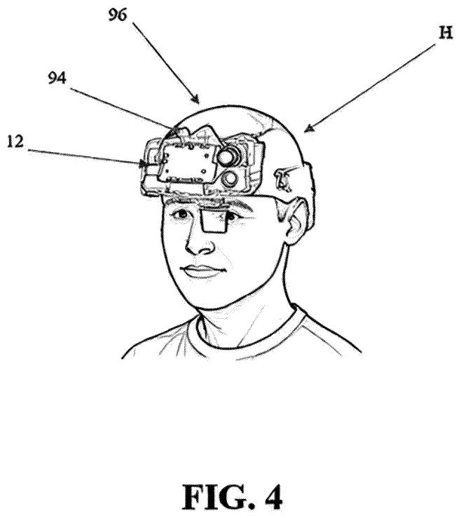

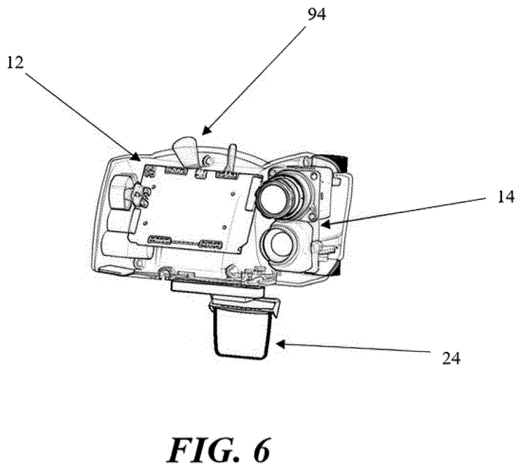

As seen in FIGS. 3-6, both reflective band Vis/NIR sensor and emissive band LWIR sensor are held contained in the main housing unit 90 with their respective optics forwardly directed from the front of the housing unit. The eye display piece 24 is operatively connected and disposed beneath the main housing unit 90 and is capable of being adjusted in its position relative to either eye of the user-operator. As best seen in FIGS. 4 and 6, the main housing unit 90 further contains the central microprocessor unit 12 with its FPGA that performs all image as well as AR data processing in control of the operation of the present inventive system.

The main housing unit 90 is adapted to be releasably mounted to the forward portion of the helmet H and further made adjustable in its position by means of a latch mechanism 94, similar in its form and structure to that described in U.S. patent application Ser. No. 14/998,979 for Digital Enhanced Vision System (DEVS) and published as US 2017/0208262, which engages a conventional shroud member 96 typically found secured upon the front of the helmet. As described in the referenced DEVS patent application, the latch mechanism 94 secured to the rear exterior of the main housing unit 90, engages the shroud 96 and provides quick and easy mounting of the housing with a vertical adjustment feature that assures that eye displays are set properly in position relative to the eyes of the personnel user when mounted on the helmet H.

Therefore, it is apparent that the described invention provides an improved visual-aid system for mobile use by military and law enforcement personnel that maximizes the visual and environmental awareness of the personnel during field operations regardless of the ambient conditions. More particularly, the disclosed present invention provides an improved visual-aid system able to be carried with and/or worn upon field personnel that is capable of providing digitally enhanced images of a site to the user-personnel selectively based on the ambient conditions with supplemental display of physical, real-world data and graphics regarding the site location and the environment of the user-personnel to enhance the situational awareness of the user-personnel. The disclosed digital enhanced vision system incorporates a low latency augmented reality display that is integrated in its design and adapted for proper placement upon the head of the user-personnel in a stable operational position near-to-eye to provide maximum performance in the field in night, day, and all-weather operations. The disclosed digital enhanced vision system is ideally suited for military reconnaissance and surveillance operations and is lightweight and portable and made conformal to standard helmets for ready engagement and balanced mounting upon the head of the operator, reducing head and neck strain over extended periods of without impairing normal head movements and sighting.

The present inventive system with low latency augmented reality display that is user-friendly in its controls and reliable in its performance, affording greater viewability and recording capabilities regardless of environment conditions. The present inventive system is user-friendly in its controls and reliable in its performance, affording greater visual enhancements and recording capabilities in all darkened and obscured environments.

A functional block diagram of the present inventive system is shown in FIG. 1. It depicts the key interrelationships for imagery and data generation, interfacing, processing and displays. It also identifies the potential external data interfaces and interface types for communicating with off-helmet systems.

A functional module within the processor domain is identified to represent the processing requirements that support the AR capability of the present inventive system. This module is expected to comprise the imagery from a Vis/NIR camera, input from external systems such as ATAK, embedded firmware that correlates and generates the meta data for observed imagery, and outputs the resultant imagery and AR meta data to the displays for operator viewing. The AR firmware will also support operator controls and preferences for selecting, filtering and controlling the data for “best” performance and display to the operator.

Note that FIG. 1 represents a notional, example architecture and shows potential for various types of sensor inputs; however, the final implementation may include any combination of sensor inputs, as needed to simultaneously meet all performance requirements for that application.

The subsystems comprising the present inventive system are as follows:

1) Head Tracking (Separate from Position Tracking)

Head tracking is a technique that combines image feature selection, registration, tracking, and helmet position and angle calculation processes to provide accurate operator helmet orientation in geospatial coordinates. A head tracking system produces absolute helmet position and angular orientation in geospatial coordinates. The present inventive system can integrate its internal image processing and other sensing technologies, with the head tracker to provide accurate battlefield airman (BA) helmet tracking at real-time video speed. This results in accurate, low latency situational awareness indications for the user.

### 2) Helmet Tracker

To achieve the proper geo-positioning of the symbology, a helmet tracker is employed so that operator position, azimuth, and elevation are measured to the required accuracy.

### 3) GPS

GPS is a component for a dismounted operator to provide geographic location in the battlefield in relation to other objects and personnel. The present system GPS will be used to feed the signal into the Augmented Reality and processing elements, and will have an internal GPS

### 4) Display

A transparent see-through display is more effective for day time operations with the AR data projected to the user. With a clear display the operator will have an unobstructed view of the day time environment when in full light condition.

### 5) Display Optics

In addition to selecting the display device it is necessary to define the optics and related technology to complete the display system and achieve the desired field of view.

### 6) Sensors

The present system requirements are for the inclusion of one reflective and one emissive band sensor. We have conducted a broad survey of the current and future market offerings with the results detailed below. Due to the overall system SWaP goals, we narrowed our focus down to products in the VIS/NIR and SWIR bands for reflective sensing and the LWIR band for emissive detection.

### 6.1) SWIR Sensor

The SWIR sensor has traditionally afforded good night and daytime performance, but with a severe power load penalty due to the use of a Thermoelectric Cooler (TEC) to stabilize FPA performance. Until such time as a TECless SWIR camera with comparable performance can be obtained, it will not be a candidate due to the low power system requirements of the present system.

### 6.2) LWIR Sensors

Experience has shown that LWIR sensors are an excellent complement to reflective bands and continual improvements have driven these devices to favorable SWaP characteristics suitable for use in the present inventive system.

### 7) Camera/Sensor Optics

Each of the various camera selections will require a corresponding lens to achieve the required Field of View as well as other desired size and weight characteristics.

LWIR lens selection is most commonly limited to what the camera manufacturer is able to supply pre-installed and calibrated to each sensor. One such suitable lens is the Boson 640, the closest standard lens selection would be the 50×40 degree foV, slightly exceeding the Threshold goal. Other suitable lens are contemplated and fall within the scope of the invention.

While there are a variety of off-the-shelf Vis/NIR lens options, it is also likely that in order to meet the image circle requirements of the large FPA and the SWaP performance desired, a custom lens will be required as part of future efforts. See FIGS. 6 and 7

### 9) Processor-Image Processing Subsystem

Selection of the present system processing element has considered the current performance requirements, as well as provisions for future growth and capability in processing needs. The selection process has also examined past work and established

In designing the present system there is an open hardware architecture that could readily be integrated with the AR software solutions available on the commercial and military market. It is difficult to define an AR software in today's market that is a stand-alone product. Most software products on the market are tied into a hardware system and must be modified and integrated with the hardware.

Each AR software developer utilizes a different hardware platform, including processor, IMU, camera, and optics. Only a handful of companies have the design flexibility and are willing to disconnect their software from the hardware and work on another company's hardware for development of a new integrated system. Because every AR software platform is tied into a hardware system, each must be modified and integrated with specific hardware to deliver optimized results.

The functions performed by the AR software overlay application in the present system will prove the AR concept of operation and its purpose in a full production system implementation. The AR software will perform the following basic tasks:

Place markers and icons on a video overlay of the scene via the display to show features of interest, compass heading, and the mission relevant data.

Read/interpret the scene as it receives data from the system sensors and cameras.

Identify scene features such as personnel and objects and make image analysis of this data on board the system processor, place markers on these features using a video overlay that is projected on the operator display.

### 8.1) Augmented Reality Symbology

The AR tactical symbology and information will be displayed on the operator's helmet mounted display. The AR overlay preferably displays MIL-STD-2525D symbology to the operator.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A digital enhanced-vision system for mobile use by field personnel, comprising:
a main housing releasably mountable to a forward portion of a helmet and having a front end;
a sensor camera grouping located at the front end and comprising electro-optical/infrared (EO/IR) sensors configured to collect observed imagery;
an adjustable eye display subsystem disposed beneath the main housing and positionable in front of either eye of a user, the eye display subsystem configured to overlay augmented-reality symbology on the user's direct view of the real world; and
an augmented-reality processing unit configured to geo-register the symbology to real-world geographic coordinates.

2. The digital enhanced-vision system of claim 1, wherein the augmented-reality processing unit comprises:
a helmet-mounted tracker subsystem configured to measure relative changes in head pose of the helmet; and
a geospatial tracker subsystem separate from the helmet-mounted tracker subsystem, the geospatial tracker subsystem configured to determine absolute three-dimensional position and absolute angular orientation of the helmet in a geospatial coordinate system, wherein geo-registration of the symbology uses data from both the helmet-mounted tracker subsystem and the geospatial tracker subsystem.

3. The digital enhanced-vision system of claim 2, further comprising a self-contained GPS subsystem mounted on the helmet and including an integrated GPS receiver and antenna, the GPS subsystem configured to independently determine and output absolute geographic position of the helmet without reliance on any external navigation aids or equipment carried by other personnel.

4. The digital enhanced-vision system of claim 3, wherein the augmented-reality processing unit fuses data from the helmet-mounted tracker subsystem, the geospatial tracker subsystem, and the GPS subsystem to maintain world-locked geo-registration of the symbology.

5. The digital enhanced-vision system of claim 1, wherein the EO/IR sensors comprise at least one reflective-band sensor and at least one emissive-band sensor.

6. The digital enhanced-vision system of claim 5, wherein the reflective-band sensor comprises one or more visible/near-infrared (Vis/NIR) sensors configured to capture light in the 400-1700 nm range, and the emissive-band sensor comprises one or more long-wave infrared (LWIR) sensors configured to capture thermal radiation in the 8-14 μm range.

7. The digital enhanced-vision system of claim 6, wherein the reflective-band sensor further comprises at least one short-wave infrared (SWIR) sensor operating in the 0.9-1.7 μm range.

8. The digital enhanced-vision system of claim 1, further comprising a field-programmable gate array (FPGA)-based central microprocessor housed within the main housing, the FPGA-based central microprocessor configured to perform real-time image processing of the observed imagery and augmented-reality data processing for the eye display subsystem.

9. The digital enhanced-vision system of claim 1, further comprising an augmented-reality overlay control subsystem configured to allow the user to select, filter, and control displayed data and symbology via operator controls.

10. The digital enhanced-vision system of claim 1, wherein the observed imagery from the sensor camera grouping and the augmented-reality symbology are both presented on the eye display subsystem.

11. The digital enhanced-vision system of claim 1, wherein the entire system, including power source, processing, sensors, and display, is integrated into the main housing and helmet such that the system operates completely independently of any backpack, vehicle-mounted, or off-body equipment.

12. The digital enhanced-vision system of claim 6, wherein the Vis/NIR sensor and the LWIR sensor are boresighted to each other and to the eye display subsystem to enable accurate fusion and overlay of visible/near-infrared imagery and thermal imagery with the geo-registered symbology.

13. The digital enhanced-vision system of claim 1, wherein the electro-optical/infrared (EO/IR) sensors further comprise at least one short-wave infrared (SWIR) sensor configured to detect reflected light in the 0.9-1.7 μm spectral band.

14. The digital enhanced-vision system of claim 1, wherein the eye display subsystem comprises first and second see-through display panels separately positionable in front of the left and right eyes of the user so as to provide binocular augmented-reality overlay.

15. The digital enhanced-vision system of claim 1, wherein all system batteries are contained within the main housing at the front of the helmet, thereby optimizing forward center-of-gravity and eliminating any need for a counterweight or rear-mounted battery pack.

16. The digital enhanced-vision system of claim 1, further comprising one or more of:
a digital enhanced zoom subsystem,
an electronic image stabilization subsystem configured to compensate for user motion while moving,
a near-far focus and parallax correction subsystem, and
a moving-target-indicator subsystem configured to automatically detect and highlight moving objects or threats.

17. The digital enhanced-vision system of claim 1, further comprising a data interface configured to (i) receive off-helmet geopositioned terrain data, mission data, or tactical information from external systems and (ii) transmit sensor imagery and processed data to external systems for networked situational awareness.

18. The digital enhanced-vision system of claim 1, wherein the augmented-reality processing unit is further configured to:
receive geopositioned information about terrain and objects around the user,
perform onboard scene analysis of imagery from the sensor camera grouping to detect and classify personnel and objects,
automatically generate and place markers, icons, compass headings, and mission-relevant data on the displayed symbology in real-time geo-registered alignment with the real world.

19. The digital enhanced-vision system of claim 2, wherein the geospatial tracker subsystem calculates absolute helmet position and angular orientation by fusing low-drift inertial measurement unit (IMU) data, video-based navigation and pointing-angle processing derived from the sensor camera grouping, and periodic position updates from the GPS subsystem when available, thereby providing continuous low-latency, high-accuracy helmet state data for real-time world-locked augmented-reality overlays; and
wherein the system further supports a digital-only operating mode in which live sensor imagery is suppressed while geo-registered symbology remains displayed.

20. A helmet-mounted digital enhanced-vision system comprising:
a protective helmet;
a main housing unit fixed at a forward portion of the protective helmet;
a sensor camera grouping disposed at a front end of the main housing unit and comprising electro-optical/infrared (EO/IR) sensors configured to collect observed imagery;
an adjustable eye display subsystem supported by the main housing unit and positionable in front of at least one eye of a wearer, the eye display subsystem configured to overlay augmented-reality symbology on the wearer's direct view of the real world;
a battery housing mounted at a rear portion of the protective helmet and containing at least one removable battery cartridge;
a power and data connection between the main housing unit and the battery housing; and
an augmented-reality processing unit configured to geo-register the symbology to real-world geographic coordinates,
wherein the entire system is carried on the helmet and operates without any off-helmet cables, backpacks, or external equipment.
